(19) United States
(12) Patent Application Publication
(10) Pub. No.: US 2004/0137956 A1
(43) Pub. Date: Jul. 15, 2004

(54) Rapid outgoing message readout system

(76) Inventor: Roy Bernard Mann, Austin, TX (US)

Correspondence Address: Roy B. Mann, 6311 Lakewood Hollow, Austin, TX, 78750, US

(21) Appl. No.: 10/726,859

(22) Filed: Dec. 2, 2003

Related U.S. Application Data
(60) Provisional application No. 60/430,186, filed on Dec. 2, 2002.

(51) Int. Cl. H04M 1/00; H04B 1/38

(52) U.S. Cl. 455/566; 455/575.1

(57) ABSTRACT

The Rapid Outgoing Message Read-out System (ROMROS) is a process or method with applications, including hardware and software, by which individuals placing calls, by telephone or any electronic device, to a party with a multi-option Outgoing Message, can peruse and interact with OM text readouts on a touch-screen or other device, rather than listen and respond to often time-consuming audio-voice options, thereby accessing the desired information, live attendant, or other end-use more rapidly than can be achieved through audio-voice options trees. The invention subsets include applications for a) recording, managing, and transmitting in text form the called party's Outgoing Messages and other displays and materials to phone callers and electronic inquirers; b) receiving, displaying, managing, and interacting with incoming textual Outgoing Messages on any touch-screen, computer, other terminal equipment, wireless phones, or any other communications device; and c) the touch-screen display device, provisionally termed ROMROS-TD, that the applicant has invented for direct connection to a telephone, wired or wireless, as an alternative to employing the ROMROS on a computer or other non-telephonic device that can utilize it.

The present application claims the priority of a co-pending Provisional Application, Serial No. 60/430,186, filed on Dec. 2, 2002.

### BACKGROUND

I. Technical Fields

The Technical fields in which the claimed invention has been developed are telephony, computer technology, and touch screen technology.

II. Related Art

1. Computers, hand-held devices, and other electronic devices present readable text as a standard and universal given. The capability for selecting a feature, including text, on the screen of such devices is effectuated through a mouse-and-cursor or keyboard functions.

Related Art Limitations: Computer and Internet accessibility have not displaced the interest of individuals to reach recorded information or live attendants via telephone, wired or wireless, or other electronic devices, including the computer itself, to obtain information that is either not available on-screen, cannot be found on-screen by the individual in question, or is being sought by an individual reliant on telephonic connectivity for any reason. Also, while many companies, institutions, and agencies have option trees in text form on their Websites, the outgoing message option trees they maintain on their telephone systems are time-consuming and aggravating to callers. According to the Inventor's records, a caller's working through a voice outgoing message tree at a large may spend as much as 2 to 4 minutes before reaching a desired end-point, whereas a caller working through text options on a computer screen can finish a comparable number of options in a matter of seconds. Even if all Websites would enable such access in the future, the problem with extant and future voice-only telephone outgoing message option trees would remain.

2. Voice-to-text technology, including TDD, enables the near-simultaneous transcription of spoken messages, as is commonly done with TV newscasts, interviews, and other programs in which the words spoken are virtually immediately followed by running text transcriptions on the device's screen.

Related Art Limitations: While this technology may seem comparable at first glance, it is not in fact. The flow of the transcription runs no faster than the speed of the spoken voice, while the supplying of the written information to the caller under the claimed invention is virtually instantaneous, creating a valuable benefit in time-saving. Furthermore, a business, agency, or other entity interested in providing a written message tree of its own would not be as interested in a verbatim transcription of its OM's full narrative sentences, which Voice-to-Text achieves. It would more likely be interested in written text more concisely tailored to keywords, thus supporting the Invention's innovative provision of rapid options. Also, the entity composing the outgoing message would not likely wish to be reliant on a voice-to-text program at the caller's end to accurately translate its message.

3. Touch-screen Technology allows the user to select options posted on the screen of a computer or other device by touching the appropriate site on the screen and thereby advancing to the next set of options or to the sequence's endpoint. Extant touch-screen technology is capable of providing the devices and software for the Inventor's Rapid Outgoing Message Readout System Touch Screen Device (ROMROS-TD), though one or more innovations may be introduced and claimed as dependent inventions by the Inventor as the ROMROS-TD prototype is developed.

Related Art Limitations: Personal computers, network workstations, laptops, and similar computer devices do not employ touch screen technology. The user of such a computer/device can, however, interact with information displayed on the screen by selecting and clicking, as described below. The innovative introduction of a textual outgoing message tree at the called party's end would take advantage of Touch-screen capabilities.

4. Select-and-Click functions, whether by keyboard or mouse, common to all computers, wireless phones, hand-held devices, and other devices are also applicable to the Inventor's claimed process.

Related Art Limitations: There are few limitations at the user's or caller's end to utilize the claimed invention. The innovative introduction of a textual outgoing message tree at the called party's end would take advantage of Select-and-Click (e.g., keyboard or mouse) capabilities where the caller works through a non-Touch-screen device.

5. Caller ID displays present CLASS information related to the caller's identification, displaying number and caller name data carried by Caller ID or CLID channels.

Related Art Limitations: Caller ID data are limited to the caller's phone number and name wording. Because of the nature and function of this CLASS data transmission, written text of an outgoing message tree cannot be transmitted via the channels used for Caller ID data.

6. Summary of Related Art Limitations: These include the non-existence of processes and supportive applications that (a) interconnect a written text display provided in the outgoing message tree of a telephone-called entity with a display screen operated by a telephonic caller (utilizing a wired telephone, wireless telephone, computer, or other device interacting with the called party at its telephone interface) and (b) provide real-time interconnectivity and interaction between caller and called party.

### SUMMARY OF THE INVENTION

The Rapid Outgoing Message Read-out System (ROMROS) is a process or method with applications, including hardware and software, by which individuals placing calls, by telephone or any electronic device, to a party with a multi-option Outgoing Message, can peruse and interact with OM text readouts on a touch-screen or other device, rather than listen and respond to often time-consuming audio-voice options, thereby accessing the desired information, live attendant, or other end-use more rapidly than can be achieved through audio-voice options trees. The invention subsets include applications for a) recording, managing, and transmitting in text form the called party's Outgoing Messages and other displays and materials to phone callers and electronic inquirers; b) receiving, displaying, managing, and interacting with incoming textual Outgoing Messages on any touch-screen, computer, other terminal equipment, wireless phones, or any other communications device; and c) the touch-screen display device, provisionally termed ROMROS-TD, that the applicant has invented for direct connection to a telephone, wired or wireless, as an alternative to employing the ROMROS on a computer or other non-telephonic device that can utilize it.

### DESCRIPTION OF THE DRAWINGS

FIG. 1 is a flow-chart describing my new process;

FIG. 2 is a perspective view of my ROMROS display device, which utilizes the process.

### DETAILED DESCRIPTION OF THE INVENTION

The claimed Invention consists of the following:

1. Development of software and mechanisms to enable the creation and installation in the outgoing message unit of an entity's PBX of Readable-Text Outgoing Messages (RTOM) text that will be transmitted to a caller, through either analog or digital service, in lieu of the standard vocalized outgoing message tree when an authorizing signal is detected by the PBX on the caller's line;

2. This authorizing signal will be embedded at the caller's telephonic device in software the inventor will develop for the caller's end. It will be transmitted, under existing technology, on a B channel or other suitable channel, whenever the caller uses the enabled phone or other telephonic device. If the caller's signal activates a RTOM unit in a called party's PBX, if this is the initial interface selected by the called party, as it frequently is in a large company or government agency, the RTOM text message will be sent back via the B channel, or other channel under new technology, to reach the caller's display device, whether the Inventor's ROMROS or another programmed telephonic or computer device is utilized;

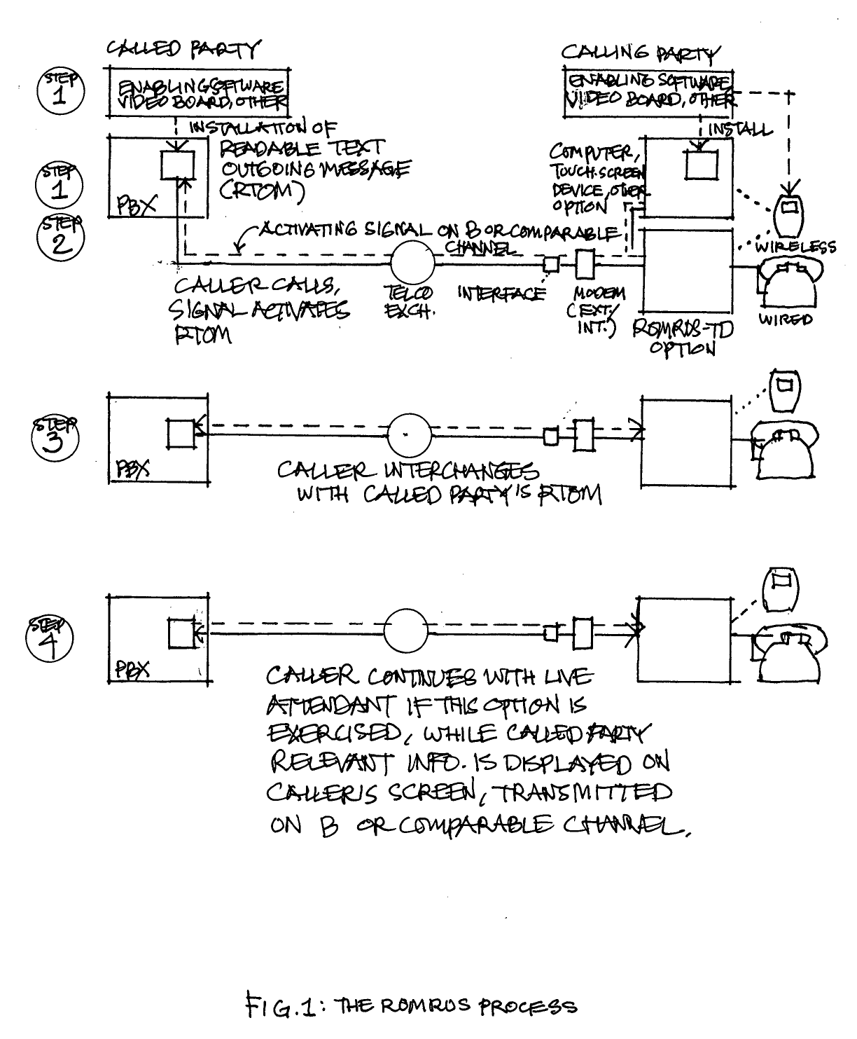

3. The received RTOM text message data will arrive, via interface, at the caller's modem, CSU, DSU, or other data communication equipment (DCE), transcribing received electronic signals into readable text form; see Part A of FIG. 1 relative to the foregoing three steps;

4. The displayed text will be read on either the Inventor's ROMROS-TD display device or any other telephonic or computer device with a compatible interactive read-out capability;

5. The caller will read and select options in the displayed outgoing message tree text, will then either select and click on the monitor's screen if a computer or similar device is used, or touch the touch screen of the Inventor's ROMROS-TD device if this is used, repeating this as necessary until the desired end-information is reached;

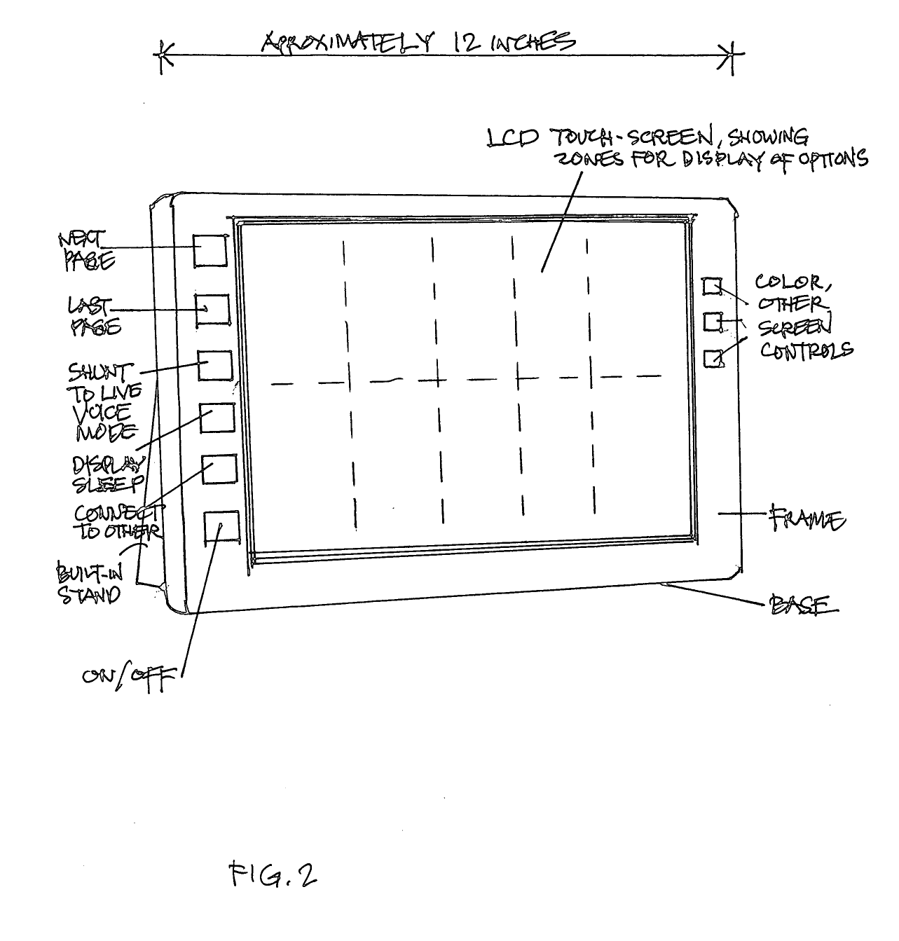

6. The text display of the ROMROS-TD device, if this device is employed by the caller rather than a computer or other enabled device, will show ten (10) options simultaneously, ten being the hypothetical maximum number of options in a single stage of an outgoing message tree. The display would have five above and five below, configured graphically in a more-or-less square layout to take advantage of efficiencies and resolution achievable in square, flat-screen devices, of which the Inventor's ROMROS-TD device is one. The caller will press or click on a button installed in the frame that encompasses the interactive display screen to signal the called party's PBX unit that the next options stage should be transmitted. This process will be repeated until the last options are read, if desired. If the end-information enables reaching a live attendant at the called party, the caller's equipment will, by pressing or clicking a frame button, shunt from the interactive screen mode and its channel to the voice-carrying line and speak with that attendant. Optionally, the called party's outgoing message can at this point switch into a read-out display of information on its products and services. The caller can press or click on another frame button or buttons to leave the display, return to voice phone connection, or end the call. Other buttons/touch controls include on/off switch, interconnection with a docked computer or other electronic device, screen luminescence, text size, screen background colors, and other features supporting readability, attractiveness, and convenience of the displays; the ROMROS-TD device is shown in FIG. 2.

7. The Inventor will develop applications that will provide the same, or comparable, functions in any computer or other device that can be enabled to carry the ROMROS (system).

### Social Utility of the Claimed Invention

At present, telephone callers seeking live assistance often encounter time-consuming outgoing message trees at business, government, and other destinations, particularly when calling large concerns with complex routing and information. For most people in ordinary circumstances, this time-absorbing process is simply wasteful and irritating. For many, however, such delays can be health- or even life threatening. The problem of the auditory-only outgoing message tree is indeed compounded if and when an individual must phone various unrelated offices or other multiple destinations to obtain information on a particular question. Whether in its simple or compounded form, the problem has critical importance at both individual and community levels when the answers being sought by callers are in the areas of emergency hospital treatment, medical insurance coverage, storm damage, terrorist attacks, and other crucial situations.

The substance of the Invention is based on the simple and universally recognized fact that the average reader can scan and comprehend written text much faster than the average listener can comprehend spoken messages. In addition, readers can move rapidly from page to page, or option set to option set, if keyword recognition is the basis of their search. This accelerates the search process over voice narrative messages even more appreciably, since the vocal narrator typically speaks in complete sentences and in measured cadences to be comprehended by all callers—young, old, hearing impaired, and so forth. It is estimated that the average caller would need from 1.5 to 4.0 seconds to be able to visually scan all option definitions presented in a single screen page and touch the desired option with a finger to proceed to the next page or stage, for an estimated average of 3 to 6 seconds for total time spent on a call-in up to the point of routing to a live attendant or other end informational access or use. This can be compared to the somewhat less than 1 minute to 2 or 4 minutes or more consumed on call-ins under the present voice-only systems.

The inventions the inventor hereby claims are a Process for transmitting, reading, and interacting with written outgoing messages and a Design for a touch-screen device that enables a caller to receive and interact with transmitted written outgoing messages, comprising the software and hardware components necessary for installation and management of the Rapid Outgoing Message Read-out System that enables textual outgoing messages at a called party terminal; software and hardware components necessary for installation and management of the rapid Outgoing Message Read-out System that enables the reading and interaction with received textual outgoing messages at a calling party terminal; and the touch-screen display and interactive device termed the ROMROS-TD, as further specified in the claims below:

1. I claim as my Invention the process overall of the Rapid Outgoing Message Readout System and the software applications and devices that make the system operable, as further defined in the Specification and in the Drawings.

2. I further claim as my invention an interactive touch-screen device, termed Rapid Outgoing Message Readout System Touch-screen Device (ROMROS-TD), as further defined in the Specification and in the Drawings, and the software applications and hardware by which the ROMROS-TD is created, that is uniquely devised to display received readable-text outgoing messages, allow the caller to engage in interactive exchange with the called party's outgoing message tree and all telephonic and other options linked to the tree, display advertisements, other business information, and other data and images on the screen after the caller switches to voice telephone conversation with a live attendant at the called party, or reaches another desired end-use.

3. I further claim as my Invention the software and devices that enable the creation, downloadability, installation, and management of an application that enables touch-screen or other screen interaction, such as select-and-click, between a caller using a computer or other electronic device, not the ROMROS-TD claimed above, and a called party's outgoing message tree through telephonic routing.
